(19) United States
(12) Patent Application Publication
(10) Pub. No.: US 2025/0383442 A1
(43) Pub. Date: Dec. 18, 2025

(54) SYSTEM AND METHOD FOR THROUGH-WALL DETECTION

(71) Applicant: Intelligent Fusion Technology, Inc., Germantown, MD (US)

(72) Inventors: Genshe CHEN, Germantown, MD (US); Xing Ping LIN, Germantown, MD (US); Bora SUL, Germantown, MD (US)

(21) Appl. No.: 19/242,878

(22) Filed: Jun. 18, 2025

Related U.S. Application Data
(60) Provisional application No. 63/661,489, filed on Jun. 18, 2024.

(51) Int. Cl. G01S 13/88; G01S 7/00; G01S 13/86

(52) U.S. Cl. CPC G01S 13/888; G01S 7/003; G01S 13/867

(57) ABSTRACT

The present disclosure provides a through-wall detection system and a through-wall detection method. The through-wall detection system includes a synthetic aperture radar (SAR), configured to scan an area of interest behind a wall to obtain SAR scanning data, where the SAR includes a linear frequency-modulated continuous-wave (LFMCW) time-division multiple access (TDMA) multi-input multi-output (MIMO) SAR; a laser range finder, configured to estimate a distance between the SAR and the wall; and further include a mobile device. A data processor is configured to pre-process SAR scanning data of all Tx-Rx antenna pairs and transfer pre-processed SAR scanning data of all Tx-Rx antenna pairs to the mobile device; and the mobile device is configured to process the pre-processed SAR scanning data of all Tx-Rx antenna pairs to generate a 2-dimensional SAR image and determine presence or absence of a target in the area of interest behind the wall.

### CROSS-REFERENCE TO RELATED APPLICATION

This application claims the priority of U.S. Provisional Application No. 63/661,489, filed on Jun. 18, 2024, the content of which is incorporated herein by reference in its entirety.

### GOVERNMENT RIGHTS

The present disclosure was made with Government support under Contract No. H9240520C0025, awarded by the United States Special Operations Command. The U.S. Government has certain rights in the present disclosure.

### FIELD OF THE DISCLOSURE

The present disclosure generally relates to the field of radar technology and, more particularly, relates to a system and a method for through-wall detection.

### BACKGROUND

A hidden chamber in a room may contain various articles, including electronics, devices, chemicals, documents, money, people and the like. Detecting the hidden chamber in the room may be critical for various operations to ensure security in humanitarian or crime scenarios. It is also important for law enforcement officers or first responders to search for and identify suspicious objects and potential threats hidden in an enclosed space. Searching the chamber may require a user-friendly and easy-to-operate sensor system (device) that may be handheld and automatically detect, locate and discriminate hidden compartments within in indoor space. Furthermore, the system (device) should have the capability to distinguish between a normal space (e.g., the space between wall studs) and an unknown space.

There is a need to detect objects behind physical structures for emergency response during natural disasters. Through-wall surveillance is important for law enforcement as research was developed in the last century. Different wall characteristics were studied; and common signal processing methods including MUSIC (multiple signal classification) were applied. Current available systems with such capabilities to detect hidden chambers may have either a large dimension, heavy weight and/or a short working range (e.g., the 3D microwave camera). In addition, the sensors corresponding to available systems may be too complicated to operate, and users may be required to undergo long training processes. Therefore, current through-wall systems (e.g., sensors) may be not suitable for desired application of first responders, where the sensors should be handheld and easy to use in various operation fields.

### BRIEF SUMMARY OF THE DISCLOSURE

One aspect of the present disclosure provides a through-wall detection system. The through-wall detection system includes a synthetic aperture radar (SAR), configured to scan an area of interest behind a wall to obtain SAR scanning data; a laser range finder, configured to estimate a distance between the SAR and the wall; and a mobile device, where the data processor is configured to pre-process SAR scanning data of all Tx-Rx antenna pairs and transfer pre-processed SAR scanning data of all Tx-Rx antenna pairs to the mobile device; and the mobile device is configured to process the pre-processed SAR scanning data of all Tx-Rx antenna pairs to generate a 2-dimensional SAR image and determine presence or absence of a target in the area of interest behind the wall. The SAR includes a linear frequency-modulated continuous-wave (LFMCW) time-division multiple access (TDMA) multi-input multi-output (MIMO) SAR. The LFMCW TDMA MIMO SAR includes an antenna system, including a plurality of transmitter (Tx)-antennas and a plurality of receiver (Rx)-antennas; a main radar board, including a radar transmitter (Tx), a radar receiver (Rx), and a micro controller, where the micro controller includes a data processor; and a radar switch board, including a logic control circuit, where the logic control circuit is configured to form a Tx-Rx antenna pair by selecting a Tx antenna from the plurality of Tx-antennas and selecting a Rx-antenna from the plurality of Rx-antennas each time in a predefined sequence.

Another aspect of the present disclosure provides a through-wall detection method. The through-wall detection method includes scanning an area of interest behind a wall with a synthetic aperture radar (SAR) to obtain SAR scanning data, where the SAR includes a linear frequency-modulated continuous-wave (LFMCW) time-division multiple access (TDMA) multi-input multi-output (MIMO) SAR that includes an antenna system, including a plurality of transmitter (Tx)-antennas and a plurality of receiver (Rx)-antennas; a main radar board, including a radar transmitter (Tx), a radar receiver (Rx), and a micro controller, where the micro controller includes a data processor; and a radar switch board, including a logic control circuit, where the logic control circuit is configured to form a Tx-Rx antenna pair by selecting a Tx antenna from the plurality of Tx-antennas and selecting a Rx-antenna from the plurality of Rx-antennas each time in a predefined sequence; pre-processing SAR scanning data of all Tx-Rx antenna pairs by the data processor and transferring pre-processed SAR scanning data of all Tx-Rx antenna pairs to the mobile device; and processing the pre-processed SAR scanning data of all Tx-Rx antenna pairs, by a mobile device, to generate a 2-dimensional SAR image and determine presence or absence of a target in the area of interest behind the wall.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1A depicts a block diagram of an exemplary through-wall detection system according to various disclosed embodiments of the present disclosure.

FIG. 1B depicts a schematic of physical arrangement of key elements of an exemplary through-wall detection system according to various disclosed embodiments of the present disclosure.

FIG. 2 depicts exemplary SAR images simulated according to various disclosed embodiments of the present disclosure.

FIG. 3 depicts an exemplary antenna system with 6 Tx-antennas and 6 Rx-antennas according to various disclosed embodiments of the present disclosure.

FIG. 4 depicts an exemplary antenna system with 3 Tx-antennas and 4 Rx-antennas according to various disclosed embodiments of the present disclosure.

FIG. 5A depicts an exemplary through-wall detection system according to various disclosed embodiments of the present disclosure.

FIG. 5B depicts another exemplary through-wall detection system according to various disclosed embodiments of the present disclosure.

FIG. 6 depicts an exemplary through-wall detection setup according to various disclosed embodiments of the present disclosure.

FIG. 7A depicts exemplary test results of a short-range zone in absence of a target behind a wall (a radar is 0.3 m from the wall) according to various disclosed embodiments of the present disclosure.

FIG. 7B depicts exemplary test results of a medium-range zone in absence of a target behind a wall (a radar is 0.3 m from the wall) according to various disclosed embodiments of the present disclosure.

FIG. 7C depicts exemplary test results of a long-range zone in absence of a target behind a wall (a radar is 0.3 m from the wall) according to various disclosed embodiments of the present disclosure.

FIG. 7D depicts exemplary test results of a medium-range zone in absence of a target behind a wall (a radar is 2.1 m from the wall) according to various disclosed embodiments of the present disclosure.

FIG. 7E depicts exemplary test results of a long-range zone in absence of a target behind a wall (a radar is 2.1 m from the wall) according to various disclosed embodiments of the present disclosure.

FIG. 8A depicts exemplary test results of a short-range zone in presence of a target 0.6 m behind a wall (a radar is 0.3 m from the wall) according to various disclosed embodiments of the present disclosure.

FIG. 8B depicts exemplary test results of a medium-range zone in presence of a target 0.6 m behind a wall (a radar is 0.3 m from the wall) according to various disclosed embodiments of the present disclosure.

FIG. 8C depicts exemplary test results of a long-range zone in presence of a target 0.6 m behind a wall (a radar is 0.3 m from the wall) according to various disclosed embodiments of the present disclosure.

FIG. 8D depicts exemplary test results of a medium-range zone in presence of a target 0.6 m behind a wall (a radar is 2.1 m from the wall) according to various disclosed embodiments of the present disclosure.

FIG. 8E depicts exemplary test results of a long-range zone in presence of a target 0.6 m behind a wall (a radar is 2.1 m from the wall) according to various disclosed embodiments of the present disclosure.

FIG. 9 depicts a schematic of true distances and radar reading distances according to various disclosed embodiments of the present disclosure.

FIG. 10 depicts a block diagram of an exemplary SAR according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

Current available systems with such capabilities to detect hidden chambers may have either a large dimension, heavy weight and/or a short working range (e.g., the 3D microwave camera). For example, it is possible to detect objects, especially moving objects, through wall using ground-penetrating radars and through-wall radars. Above-mentioned radars may use a frequency-modulated continuous-wave (FMCW) radar architecture operating at S-band radar, where a portion of the radar signal may penetrate a wall, with a center frequency of 3 GHz with a 2 GHz ultrawideband chirp. The radars may demonstrate promising results for object detection behind wall. However, above-mentioned radar devices may be large and not portable. With 44 image-antennas and 21 actual-antennas, entire antenna structure may be 2.4-meter wide, which may be not suitable for handheld applications. Furthermore, the radar sensors may be too complicated to operate, and users may be required to undergo long training processes. Therefore, current through-wall systems (e.g., sensors) may be not suitable for desired application of first responders, where the sensors should be handheld and easy to use in various operation fields.

Deep learning (DL) may be configured to enhance synthetic aperture radar (SAR) methods. Exemplarily, deep learning may be applied to support through-wall imaging. Using additional knowledge of the target structure may help to discern the objects behind an occlusion. An example of the object may be to discern human pose estimation. However, exploiting DL may require new designs in the support of data collection from through-wall designs.

Multi-input multi-output (MIMO) radar may offer new techniques to process the radar signal. Building on the MIMO concept, time-division multiple access (TDMA) may enhance SAR processing which may be configured for hidden chamber detection. Certain approaches may be developed for gated range scanning using linear frequency-modulated continuous-wave (LFMCW) structure. Using a laser to detect the range may enhance the resolution for through-wall radar.

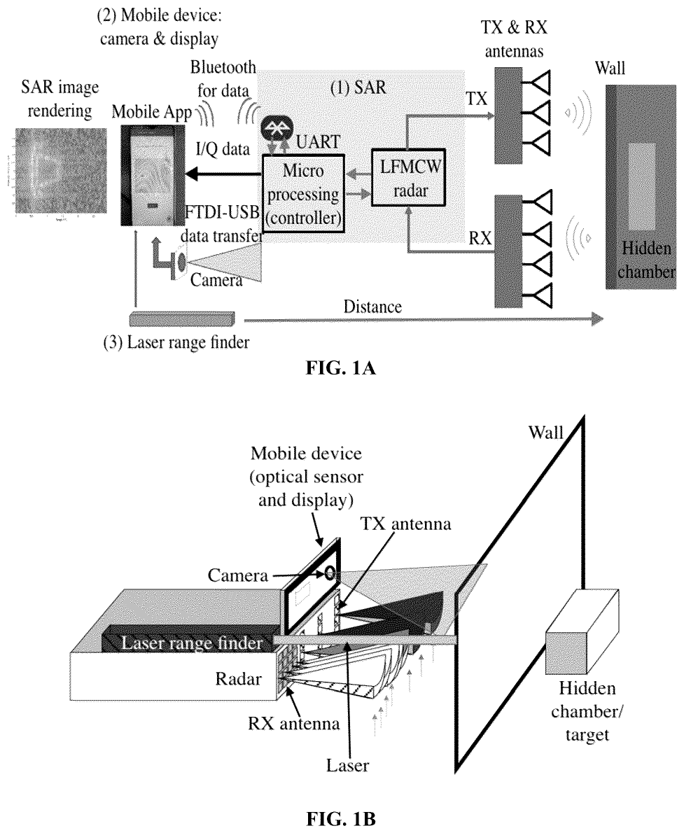

According to various embodiments of the present disclosure, a through-wall detection system is described hereinafter. FIG. 1A depicts a block diagram of an exemplary through-wall detection system according to various disclosed embodiments of the present disclosure; FIG. 1B depicts a schematic of physical arrangement of key elements of an exemplary through-wall detection system according to various disclosed embodiments of the present disclosure.

Referring to FIGS. 1A-1B, the through-wall detection system includes a synthetic aperture radar (SAR), configured to scan an area of interest behind a wall to obtain SAR scanning data; a laser range finder, configured to estimate a distance between the SAR and the wall; and a mobile device, where the data processor is configured to pre-process SAR scanning data of all Tx-Rx (i.e., TX-RX) antenna pairs and transfer pre-processed SAR scanning data of all Tx-Rx antenna pairs to the mobile device; and the mobile device is configured to process the pre-processed SAR scanning data of all Tx-Rx antenna pairs to generate a 2-dimensional SAR image and determine presence or absence of a target in the area of interest behind the wall. The SAR includes a linear frequency-modulated continuous-wave (LFMCW) time-division multiple access (TDMA) multi-input multi-output (MIMO) SAR. The LFMCW TDMA MIMO SAR includes an antenna system, including a plurality of transmitter (Tx)-antennas and a plurality of receiver (Rx)-antennas; a main radar board, including a radar transmitter (Tx), a radar receiver (Rx), and a micro controller, where the micro controller includes a data processor; and a radar switch board, including a logic control circuit, where the logic control circuit is configured to form a Tx-Rx antenna pair by selecting a Tx antenna from the plurality of Tx-antennas and selecting a Rx-antenna from the plurality of Rx-antennas each time in a predefined sequence. In one embodiment, the micro controller and the data processor may be two separated elements.

In one embodiment, the mobile device includes a camera system that is configured to record an image of the area of interest scanned by the SAR and overlay the image of the area of interest with the 2-dimensional SAR image.

In one embodiment, the camera system is further configured for infrared imaging and/or providing illumination.

In one embodiment, the micro controller is further configured to use the distance, which is between the SAR and the wall and estimated by the laser range finder, to select a corner frequency of a high-pass filter to suppress a reflection signal adjacent to the target.

In one embodiment, the micro controller is further configured to automatically select a range zone based on the distance which is between the SAR and the wall and estimated by the laser range finder, where the range zone is any one of a short-range zone, a medium-range zone and a long-range zone; and based on the range zone selected, apply a distance-dependent weight function to calculate a distance between the target and the SAR.

In one embodiment, the distance-dependent weight function is defined as a distance between the SAR and the target=r^{4+w}, where r denotes the distance between the SAR and the wall, and w denotes a weighted value dependent on the range zone selected.

In one embodiment, for the short-range zone, w is defined to be w>0; for the medium-range zone, w is defined to be w=0; and for the long-range zone, w is defined to be w<0.

In one embodiment, the SAR operates at a range of 24.0-26.5 GHz.

In one embodiment, the plurality of Tx-antennas and the plurality of Rx-antennas are arranged at an interval of ½ wavelength of a SAR operating frequency along a same axis.

In one embodiment, the antenna system includes 6 Tx-antennas and 6 Rx-antennas; or 3 Tx-antennas and 4 Rx-antennas; or 1 Tx-antenna and 4 Rx-antennas.

In one embodiment, the SAR is powered by one or more rechargeable batteries.

In one embodiment, the mobile device is communicated with the SAR through a wired or wireless manner.

IC-Thru (a multimodal sensing system integrated with a laser range finder and optical/thermal cameras in a Smart Phone) may be configured for detecting objects hidden behind walls. IC-Thru may be a handheld K-band gated LFMCW TDMA MIMO SAR. IC-Thru may be approximately the size of two iPhones, which may satisfy low size, weight and power (SWaP) requirements. IC-Thru may operate for 2 hours continuously and be powered by two AA-sized rechargeable batteries (e.g., Tenergy Li-ion 18650, 3.6 V, 2200 mAh and 46 g). Entire through-wall detection system (radar system) including the batteries may weigh only 900 g.

Referring to FIGS. 1A-1B, the through-wall detection system (radar system) may include three components: a K-band gated LFMCW TDMA MIMO SAR radar, a phone (i.e., mobile device) with a screen displaying scanning data and an optical camera with infrared (IR) image assistance, and a laser range finder. The through-wall detection system in the present disclosure adapts a low size, weight and power (SWaP) design. As shown in FIGS. 1A-1B, the TDMA MIMO SAR radar may include 3 transmitter (Tx)-antennas and 4 receiver (Rx)-antennas, which may form 12 (3×4) antenna-phase-centers in total emulating 12 individual antennas. An antenna switch control circuit may select a Tx-Rx antenna pair each time in a predefined sequence. In one embodiment, analog-to-digital conversion (ADC) may sample data from each position of Tx-Rx combinations, which may allow for wider sensing. Scanning using all antennas at 12 positions may be completed within 40 ms (ADC sampling time for each Tx-Rx position is <1 ms), which may be significantly shorter than a typical muscle relaxation time constant (e.g., 300 ms). Therefore, it may be assumed that the radar may remain stationary while all 12 Tx-Rx antenna pairs finish scanning the search area, which may afford the data processing to form an image. The radar may effectively emulate one SAR antenna moving at 12 different positions and forming a 2-dimensional image in azimuth and range directions.

In one embodiment, the radar and the phone (i.e., phone unit or mobile device) may communicate through communication links established by either Bluetooth or a USB-cable. Raw data may be pre-processed in micro-processor (e.g., micro controller) of the radar and transferred to the phone. The phone unit may process received data to a 2-dimensional SAR image and display the image and analyze results on the phone screen. The phone unit may also contain a camera system that provides an option for infrared imaging and/or illumination assistance. Additionally, the camera system may be configured to record the images of areas (e.g., wall position) scanned by the radar and overlay the images of areas with SAR images.

The laser range finder attached to the through-wall detection system (radar system) may estimate the distance to the wall in the field of view. The range information may be configured as the reference to assist users interpret the processed data more easily. Additionally, the range information may be configured for the SAR algorithm to select adequate corner frequency of a high-pass filter, which may suppress strong reflection signal from corresponding nearby objects and improve detection capabilities for the objects hidden behind the wall. The object location may be determined using a distance-dependent weight function, which may be desirably selected based on distance-to-wall information. The strength of Rx signal may be inversely proportional to rⁿ, where r denotes the distance to a target, and n is 4 in radar applications. In the present disclosure, a weight function may be added to amplify the signal only in a specific distance range of interest. Exemplarily, a weight function, r^{4+w} may be configured to compensate the signal attenuation, where w values may be dependent on the distance ranges in an area of interest.

For a short-range zone, w may be configured to be w>0; and the selection may suppress the signal in a far-field, which is likely the reflection from the environment and radar's internal noise. For a medium-range zone, w may be configured to be w=0. For a long-range zone, w may be configured to be w<0; and the selection may be to bias a target detection in a long range and avoid the noise in the radar's vicinity.

Based on the wall distance given by the laser range finder, SAR algorithm may automatically select the distance range and corresponding weight function to find targets behind the wall.

Finally, the signal processing and analyses may be performed using an App developed for an Android system. The App may assist users to establish Bluetooth communication between the phone and the radar, process the SAR data, and display 2-dimensional object images on the phone screen. The detection system may provide options for users to search for hidden objects in multiple distance ranges including the short-range zone, the medium-range zone, and the long-range zone. In processing SAR data, the radio-frequency signal, which attenuates with travel distance, may be compensated desirably in corresponding range zone. For each zone, the app may display the 2-dimensional SAR image of scanned area along with the presence/absence of hidden targets and corresponding dimension. The detection system may also display other sensor fusion results, which may include the SAR image, radar analysis results, the image of search area captured by the camera of the phone, and the reference location of the wall measured by the laser finder.

According to various embodiments of the present disclosure, LFMCW TDMA MIMO SAR radar is described in detail hereinafter.

In determining operation frequency, it may need to consider two key factors including the through-wall signal loss and the radar size. Three different bands, that is, S-band (2-4 GHZ), K-band (12-40 GHz) and Millimeter-band (66 GHz), may be used in most radar applications made with electrical components easily accessible in the market. S-band may have the lowest through-wall loss, but entire antenna unit may become extremely large for handheld applications. Conversely, millimeter-band may have the greatest through-wall loss, but the minimum distance between the antennas may be the smallest. Therefore, 24-GHz signal band may be selected as an operation frequency, where the through-wall loss may remain not too high while the size of radar may be small enough to be one-hand-held.

In one embodiment, the radar may include three major hardware components including a main radar board, a radar switch board for Tx and RX, and radar antennas. The main radar board may include a radar Tx (transmitter), a radar Rx (receiver), a micro controller, a data processor, and a LFMCW generator. The radar switch board for Tx and RX may include a logic control circuit, and an antenna switch board. The radar antennas may include antennas and corresponding antenna driver circuits.

The radar may operate at 24.0-26.5 GHz range and include one upper-converter at Tx and two-stage down-converters in Rx. In one embodiment, the radar may include 6 Tx-antennas, 6 Rx-antennas, and 20 antenna phase-centers with only one transmission and receiving channel. The signal may be transmitted from each of 6 transmission antennas at a time in a programmed sequence. Likewise, the receiver may receive reflected signals from 6 antennas in a predetermined sequence.

The bandwidth of the LFMCW radar may be programmable within the range of 1.0-2.5 GHZ, which may yield 7.5-cm range resolution. The cross-resolution may depend on the quantity of antennas in actual applications.

According to various embodiments of the present disclosure, SAR image simulation is described in detail hereinafter.

The radar with different antenna designs may be assessed by simulating radar's capabilities to detect target and form 2-dimensional images. The list of parameters and conditions in simulation may include target types and conditions, parameters affecting SAR image, and default parameter values used in simulation. The target types and conditions may include a chamber behind a two-layer drywall, no signal dispersion at the target surface, and a far-field imaging method applied. The parameters affecting SAR image may include a quantity of virtual antennas in the MIMO array, a signal bandwidth, a distance from the wall/target to the radar, a chamber size, and a wall thickness. The default parameter values used in simulation may include a quantity of array elements (20), a distance from the radar to the wall (0.5 m), a signal bandwidth (2 GHz), a wall thickness (0.1 m), a chamber size (1 m×1 m), and a gap between two wall-layers (0.05 m).

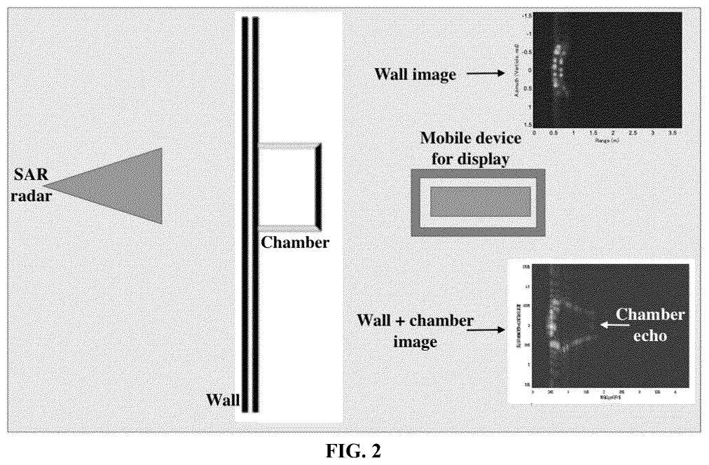

FIG. 2 depicts exemplary SAR images simulated according to various disclosed embodiments of the present disclosure. FIG. 2 show the image of the wall only, and the image of both the wall and the chamber. Referring to FIG. 2, as shown in the simulation results, the chamber (target) may be detected by the radar, and the SAR algorithm may display the shape of the chamber (i.e., the chamber echo/signal indicated by the white arrow in FIG. 2) using the listed radar parameters and target's conditions. The SAR image resolution may increase with the quantity of antenna elements. Furthermore, the image resolution may decrease with the distance between the wall and the radar and the distance between the hidden chamber and the wall. Tradeoff may be between the radar's capabilities and SWAP characteristics, that is, the higher resolution/accuracy and the greater operation range may require a larger size of the radar and an increased signal processing time.

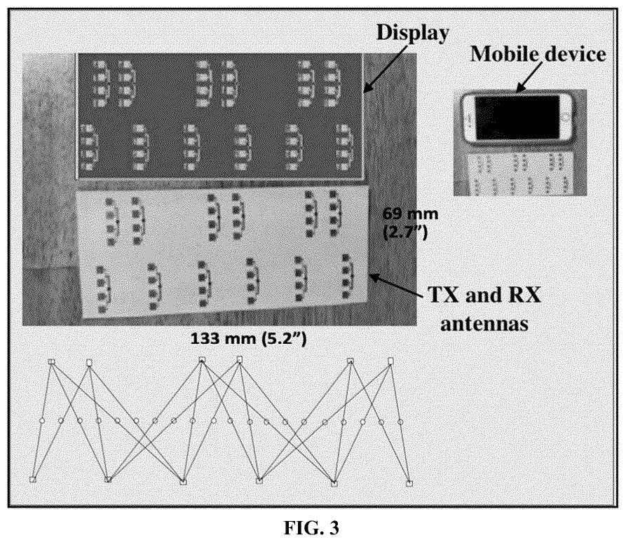

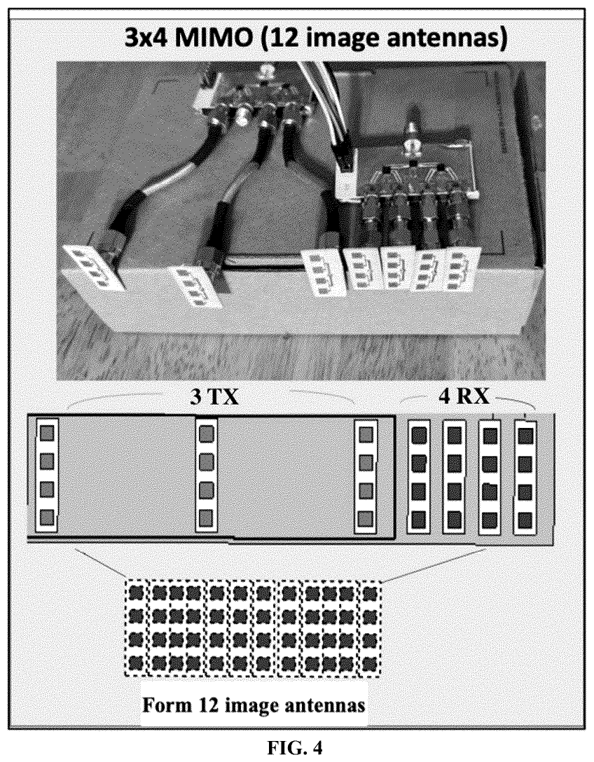

FIG. 3 depicts an exemplary antenna system with 6 Tx-antennas and 6 Rx-antennas according to various disclosed embodiments of the present disclosure; and FIG. 4 depicts an exemplary antenna system with 3 Tx-antennas and 4 Rx-antennas according to various disclosed embodiments of the present disclosure. To determine desirable quantity of Tx-antennas and Rx-antennas, the sizes of antennas, the signal loss at switches, the time required to scan, and the gain in the target resolution may be considered. In one embodiment, the radar may be configured with 6 Tx-antennas and 6 Rx-antennas, which may form 20 image-antennas at the interval of ½ wavelength of a radar operating frequency; and the size of entire antenna system may be approximately the size of an iPhone (size of 69 mm×133 mm as shown in FIG. 3). In one embodiment, referring to FIG. 3, each rectangle may represent an antenna, the lines may be signal paths between Tx-antennas and Rx-antennas; and the circles may be outcome images formed. In the present disclosure, the antennas may be placed on the front face of the iPhone-sized radar and a microstrip board at an interface layer between any other part of the radar and the antennas. However, due to complexity of the detection system, the detection system may be simplified using a different antenna arrangement. First, to reduce the antenna height, Tx-antennas and Rx-antennas may be arranged along a same axis. Next, a smaller quantity of Tx-antennas and Rx-antennas, that is, 3 Tx-antennas and 4 Rx-antennas, may be configured to form 12 image-antennas at ½-wavelength intervals (as shown in FIG. 4).

In the SAR radar antenna system, the cross-resolution Δ may be defined as:

$$Δ = \frac{λ}{2 L} r \qquad ( 1 )$$

where λ, L, and r denote a wavelength of a radar operating frequency, a total antenna length, and a range between the radar and the target, respectively. With N quantity of image-antennas (image antennas) at the interval of λ/2, the cross-resolution Δ may be:

$$Δ = \frac{λ}{2 N λ / 2} r = \frac{r}{N} \qquad ( 2 )$$

Therefore, for MIMO 3×4 antennas, which may form the array with 12 image-antennas, the cross-resolution at 2-m range may be 16.7 cm. Similarly, when the radar is 0.8-m away from the wall and the hidden chamber is 0.2-m away from the wall, the cross-resolution may be 8.4 cm.

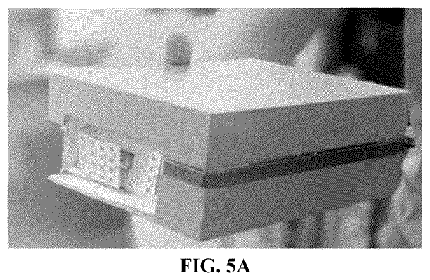

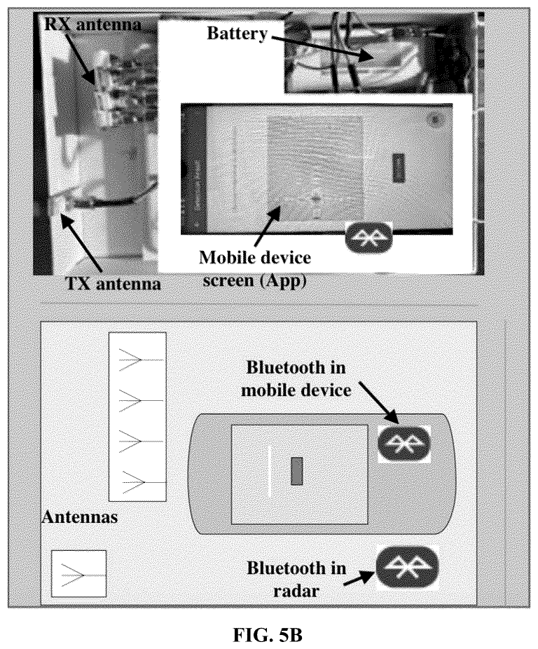

FIG. 5A depicts an exemplary through-wall detection system according to various disclosed embodiments of the present disclosure; and FIG. 5B depicts another exemplary through-wall detection system according to various disclosed embodiments of the present disclosure. Three different MIMO antenna systems including 6×6 antennas, 3×4 antennas and 1×4 antennas (as shown in FIGS. 5A-5B) may be compared. After evaluation of the balance between the radar's performance and low SWaP characteristics, the radar may be determined to be configured with the antenna system of 1 Tx-antennas and 4 Rx-antennas with each antenna having 4 patch-array-elements. The antenna system (unit) may be modular, such that users may choose or replace the antenna system from 6×6, 3×4 and 1×4 Tx-Rx options. Various antenna configurations may provide flexible options to users to easily select antennas depending on the requirements for the radar size, power consumption, and image resolution. Referring to FIG. 5B, built-in rechargeable 2 AA-size batteries may be configured in the radar; and the mobile device may communicate with the radar through a wireless manner (e.g., Bluetooth).

The radar may have the size of 20×15×5 cm. The specification of the radar of through-wall handheld MIMO SAR (as shown in FIGS. 5A-5B) may be listed as the following. The operation frequency may be 24-26 GHz; the bandwidth may be 2 GHz; the range resolution may be 7.5 cm; the sweep time (programmable) may be 512 s; the Tx power may be 10 mW; the operating voltage may be 7-8.8 V; the power consumption may be 2.4 W; the power source may be built-in rechargeable 2 AA-size batteries (e.g., Tenergy Li-ion 18650, 7.4 V, 2200 mA, operates for >2 hours continuously); the display for SAR images and analyses results may be the phone screen; the communication link between the radar and display devices (e.g., phone or computer) may be Bluetooth and/or FTDI (future technology devices international)-USB cable for secure wire connection; the size of detectable chamber or objects may be >61×61×91 cm in an average-size room (i.e., 168 ft²); and the detection range may be 0.5-3.0 m for targets hidden behind a wall made of a commercial plywood (5 mm thick).

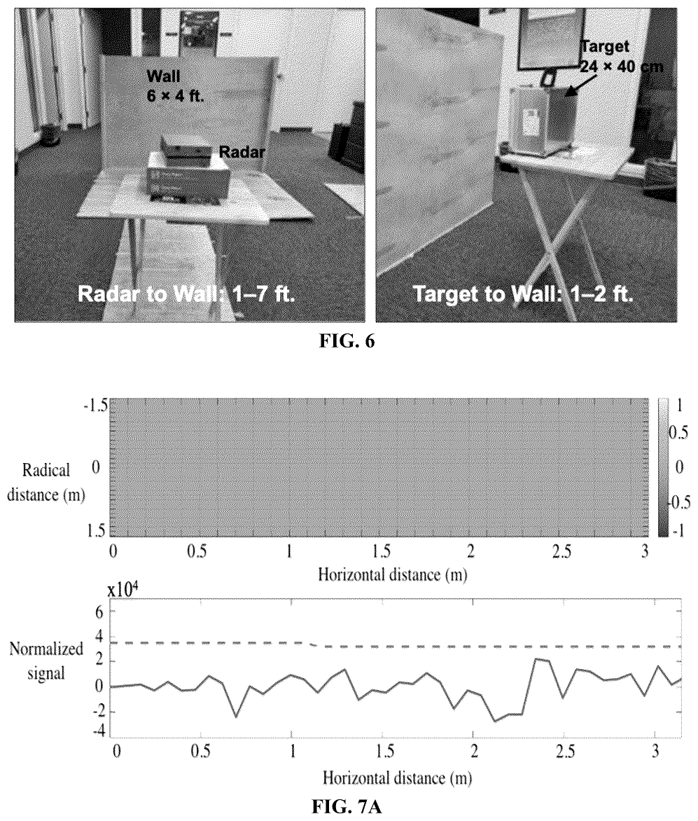

FIG. 6 depicts an exemplary through-wall detection setup according to various disclosed embodiments of the present disclosure. The noise floor, which came from the electric noise in the radar device, the environment and the clutter may be initially characterized. Using above initial test as a baseline, the detection system may extract the signal from the background noise and determine the detection capabilities for the radar using the setup shown in FIG. 6. The wall may be made of a 5-mm thick commercial plywood (6×4 ft); and a 24×40 cm aluminum case may be placed 1 or 2 ft behind the wall. The radar may be positioned on a table, or a person may hold the radar pointing at the wall at distances 1-7 ft. The phone (e.g., Samsung Galaxy A10) may be connected to the radar wirelessly and monitor scanning data. At each distance, the wall may be scanned using the App for 3 zones including the short-range, the medium-range, and the long-range.

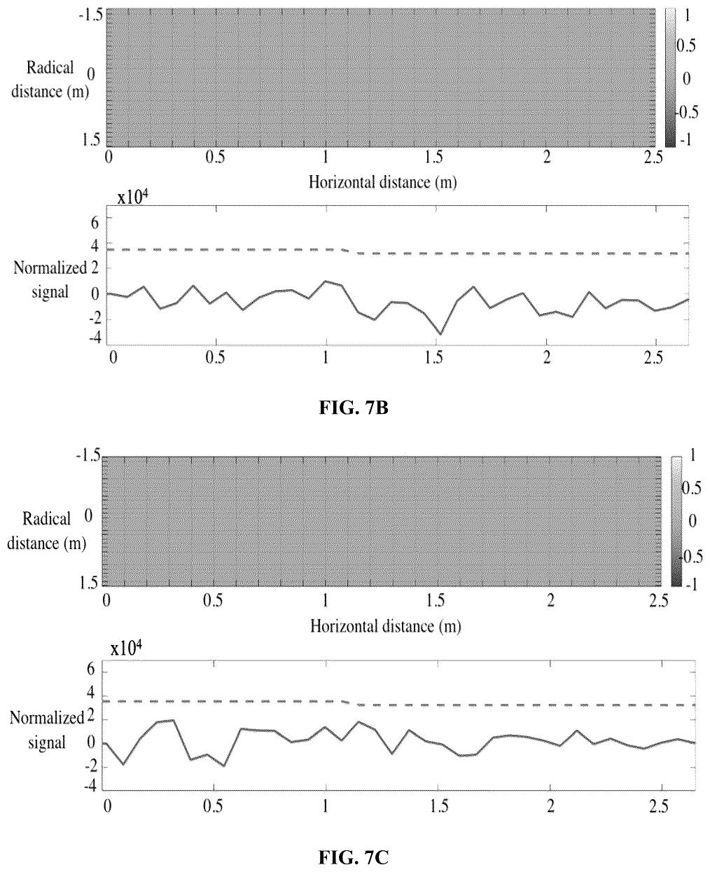

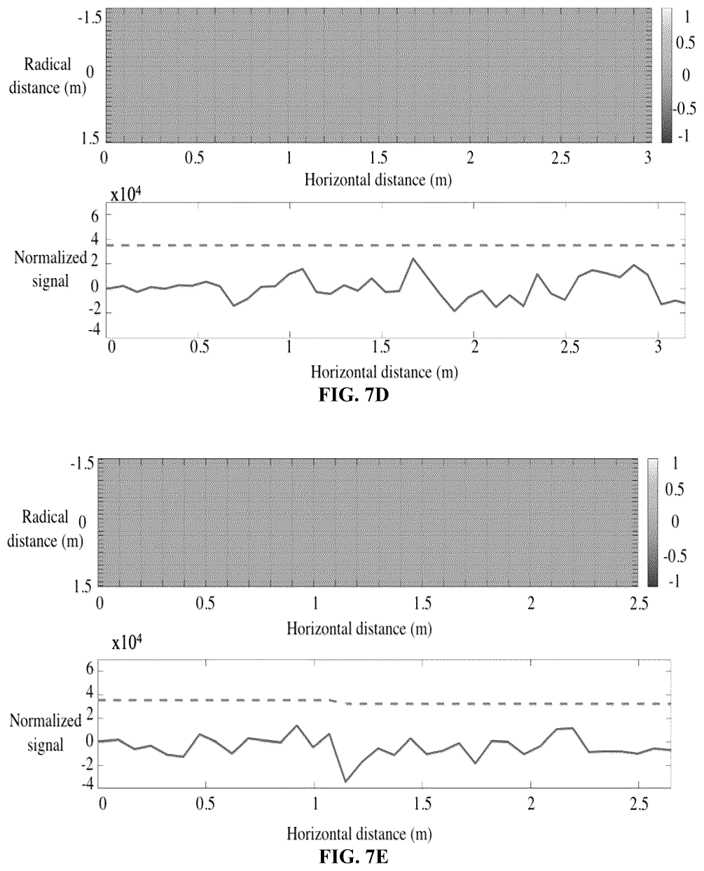

FIG. 7A depicts exemplary test results of a short-range zone in absence of a target behind the wall (the radar is 0.3 m from the wall) according to various disclosed embodiments of the present disclosure; FIG. 7B depicts exemplary test results of a medium-range zone in absence of a target behind the wall (the radar is 0.3 m from the wall) according to various disclosed embodiments of the present disclosure; FIG. 7C depicts exemplary test results of a long-range zone in absence of a target behind the wall (the radar is 0.3 m from the wall) according to various disclosed embodiments of the present disclosure; FIG. 7D depicts exemplary test results of a medium-range zone in absence of a target behind the wall (the radar is 2.1 m from the wall) according to various disclosed embodiments of the present disclosure; and FIG. 7E depicts exemplary test results of a long-range zone in absence of a target behind the wall (the radar is 2.1 m from the wall) according to various disclosed embodiments of the present disclosure.

Referring to FIGS. 7A-7E, in each plot, the upper panel shows a 2D contour map of radar signal strength; the x-axis represents the horizontal (azimuth) distance from the radar, and the y-axis represents the radial distance (range) to the target; the range may span from −1.5 m to +1.5 m which indicates that the radar may scan 1.5 meters to the left and right of the radar center; and the signal strength values may range from −1 to 1, as indicated by the color bar on the right side of the upper panel. Referring to FIGS. 7A-7E, in each plot, the lower panel shows a 1D plot of normalized signal strength (y-axis) versus horizontal distance to the target (x-axis); the dashed line represents a detection threshold configured to distinguish the target from background noise; and the y-axis may range from −4E4 to 6E4, which may indicate the minimum and maximum normalized signal levels. Multiple tests may be configured to verify the capabilities for the through-wall detection system (radar system) to correctly detect the presence or absence of the hidden target and measure the distance of the target from the radar. Referring to FIGS. 7A-7E, all three different range zones, the through-wall detection system (radar system) may correctly indicate the absence of the target (that is, no target) at any distances between the radar and the wall.

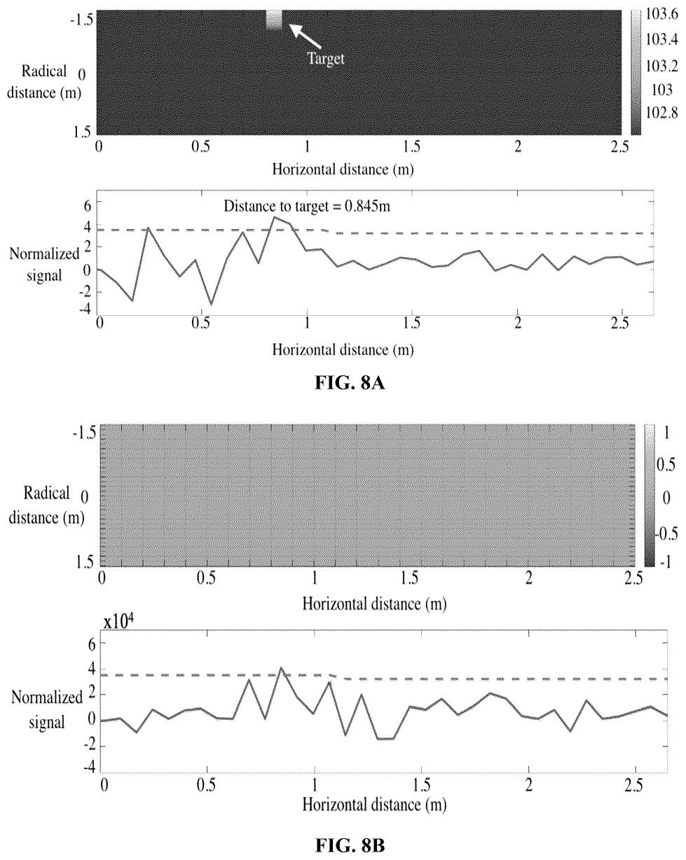

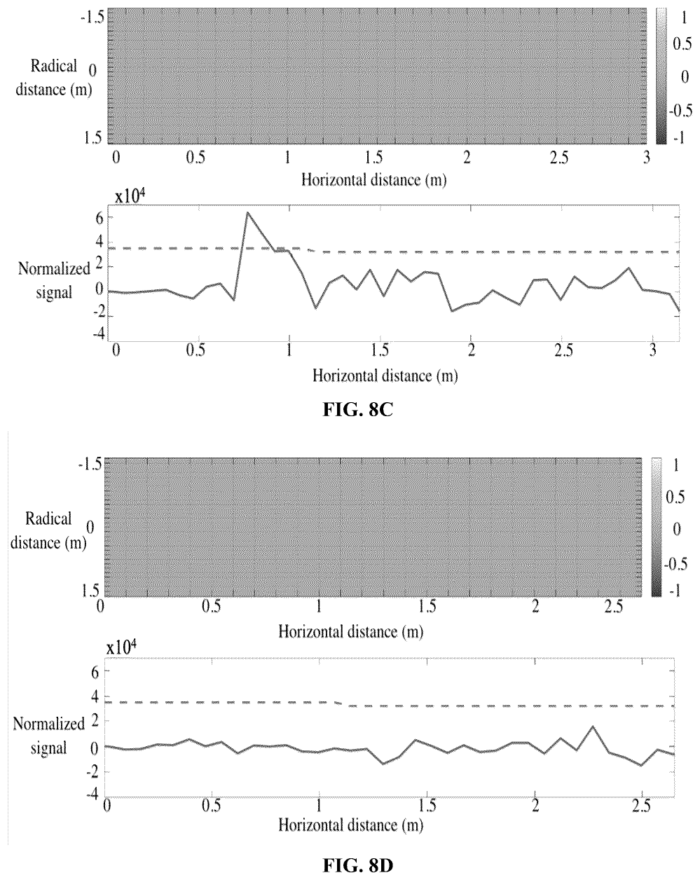

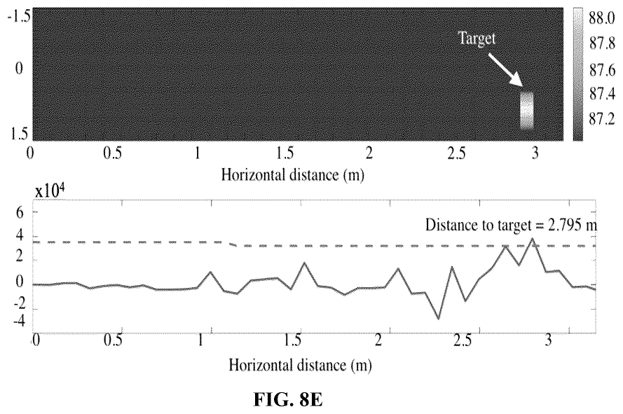

FIG. 8A depicts exemplary test results of a short-range zone in presence of a target 0.6 m behind the wall (the radar is 0.3 m from the wall) according to various disclosed embodiments of the present disclosure; FIG. 8B depicts exemplary test results of a medium-range zone in presence of a target 0.6 m behind the wall (the radar is 0.3 m from the wall) according to various disclosed embodiments of the present disclosure; FIG. 8C depicts exemplary test results of a long-range zone in presence of a target 0.6 m behind the wall (the radar is 0.3 m from the wall) according to various disclosed embodiments of the present disclosure; FIG. 8D depicts exemplary test results of a medium-range zone in presence of a target 0.6 m behind the wall (the radar is 2.1 m from the wall) according to various disclosed embodiments of the present disclosure; and FIG. 8E depicts exemplary test results of a long-range zone in presence of a target 0.6 m behind the wall (the radar is 2.1 m from the wall) according to various disclosed embodiments of the present disclosure. FIG. 8A-8E illustrate the test results when the target was 0.6 m behind the wall. Referring to FIGS. 8A-8C, when the radar was 0.3 m from the wall, the radar reading may be negative in the medium-range zone (1-2 m) and the long-range zone (2-3 m); and the through-wall detection system (radar system) may detect the target at 0.85 m (the target is indicated by the white arrow shown in FIG. 8A) in the short-range zone (<1 m), which may match with the true target distance (0.6 m+0.3 m=0.9 m) from the radar. Referring to FIGS. 8D-8E, similarly, when the radar was 2.1 m from the wall, the through-wall detection system (radar system) may not detect the target in both the short and medium-range zones and correctly read the target distance at 2.75 m (the target is indicated by the white arrow shown in FIG. 8E) in the long-range zone.

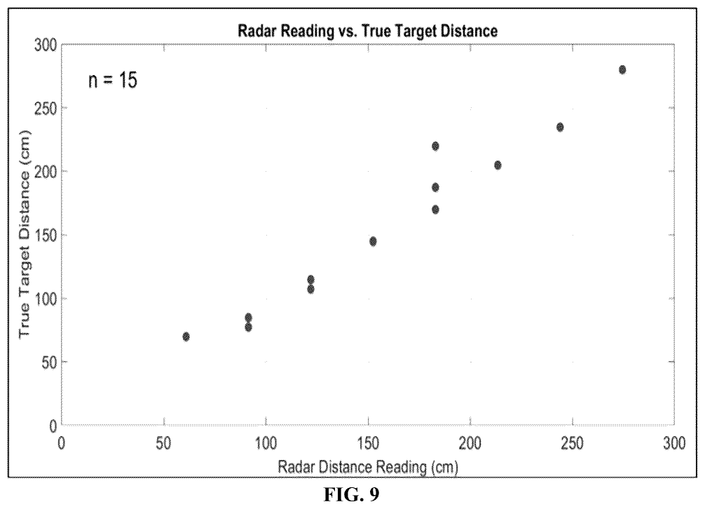

FIG. 9 depicts a schematic of true distances and radar reading distances according to various disclosed embodiments of the present disclosure. Referring to FIG. 9, in less than 3 m distance between the radar and the target, the distance readings from the through-wall detection system (radar system) may desirably agree with the true target distances. In FIG. 9, n=15 may indicate the number of repeated measurements conducted for each true distance. For each true distance value, the radar distance may be measured 15 times. Since the radar readings are often identical, significant amount of data points may be overlapped with each other at a same position.

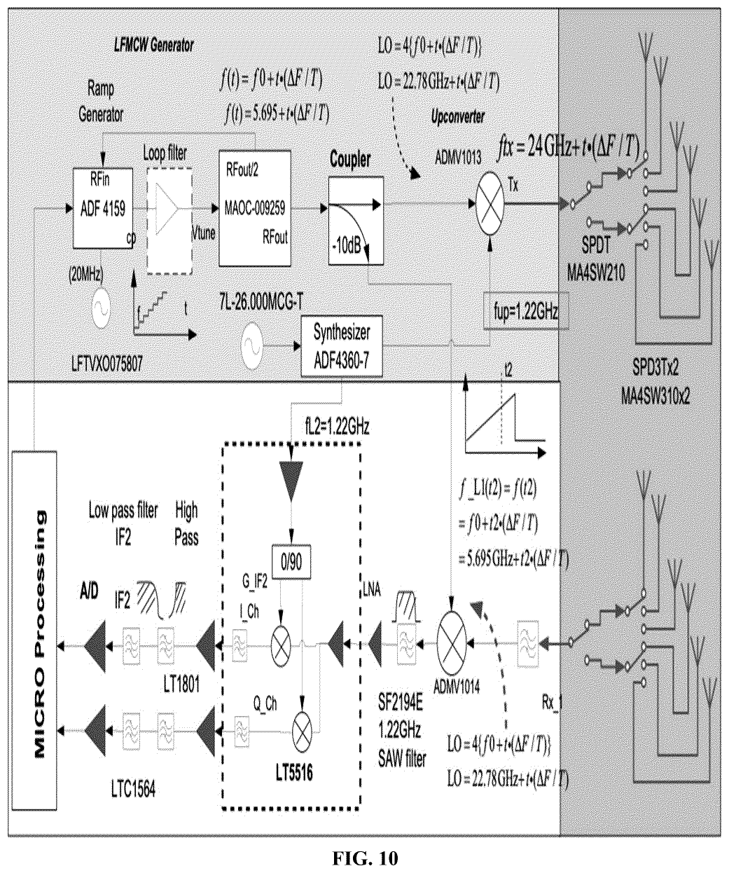

FIG. 10 depicts a block diagram of an exemplary LFMCW TDMA MIMO SAR according to various disclosed embodiments of the present disclosure. In one embodiment, referring to FIG. 10, the transmitter and the receiver may contain two-stage converters to obtain the signal with desired frequency from the intermediate frequency signal; the mixer ADMV1014 at receiver may down-convert the received signal to the first intermediate frequency IF=1.22 GHz; then the SF2194 SAW filter (700 kHz bandwidth) may filter the signal for the second stage mixer LT5516 to down-convert the 1.22 GHz signal directly into the base band; after amplification, a band pass filter may remove the radar transmission leakage back into the receiver; the 8 poles programmable LTC1564 low-pass filter may adapt corresponding corner frequency with different LFMCW scanning rate and operation range; two channels ADC may sample the base band signal; and the micro-processor may control the LFMCW generation and gating and also process the digitalized data for further range/gating/FFT processing. In one embodiment, LFMCW TDMA MIMO SAR may be a two-stage Tx structure and two-stage Rx structure. Exemplarily, the transmitter may transmit LFMCW signal ftx=24 GHZ˜26.5 GHZ; the transmission signal may be sent out sequentially at 6 Tx-antennas, and 6 Rx-antennas may receive the reflected radar in the arranged order; the mixer ADMV1014 at receiver may down-convert the received signal to the first intermediate frequency IF=1.22 GHz and the SF2194 SAW filter (700 kHz bandwidth) may filter the signal; the second stage mixer LT5516 may down-convert the 1.22 GHz signal directly into the base band; after amplification, a band pass filter may remove the radar transmission leakage back into the receiver; the 8 poles programmable LTC 1564 low pass filter may adapt corresponding corner frequency with different LFMCW scanning rate and operation range; two-channel ADC may sample the base band signal; and the micro-processor may be configured to control the LFMCW generation and gating and also process the digitalized data for further range/gating/FFT processing.

In the present disclosure, IC-Thru, that is, the handheld K-band gated LFMCW TDMA MIMO SAR through-wall detection system (radar system) is provided. The through-wall detection system (radar system) design may include multimodality sensing using K-band MIMO SAR. The through-wall sensing system may include the TDMA MIMO SAR radar, the laser range finder, and the smartphone device with software developed for Android system. The data sampled in the radar may be transferred to the smartphone device either by Bluetooth or a secure wire connection. The App installed in Android system may process the data that may be fused with images taken by electro-optical and/or infrared camera to improve the accuracy and interpretability of the radar readings. The App may process the data at three different range zones including short, medium, and long ranges for gating and optimization. The laser range finder may be utilized to localize the wall in the scanning area and assist to prioritize and optimize the detection process. Final analysis results (2-dimensional SAR image of the scanned area, presence/absence of the target, and the distance of the target from the radar) may be displayed on the phone screen through a user-friendly graphic interface. Entire through-wall detection system (radar system) may be verified for capabilities to correctly detect presence/absence of a target hidden behind a wall and corresponding location up to 3-m away from the radar.

Various embodiments the present disclosure provide a through-wall detection method. The through-wall detection method includes scanning an area of interest behind a wall with a synthetic aperture radar (SAR) to obtain SAR scanning data, where the SAR includes a linear frequency-modulated continuous-wave (LFMCW) time-division multiple access (TDMA) multi-input multi-output (MIMO) SAR that includes an antenna system, including a plurality of transmitter (Tx)-antennas and a plurality of receiver (Rx)-antennas; a main radar board, including a radar transmitter (Tx), a radar receiver (Rx), and a micro controller, where the micro controller includes a data processor; and a radar switch board, including a logic control circuit, where the logic control circuit is configured to form a Tx-Rx antenna pair by selecting a Tx antenna from the plurality of Tx-antennas and selecting a Rx-antenna from the plurality of Rx-antennas each time in a predefined sequence; pre-processing SAR scanning data of all Tx-Rx antenna pairs by the data processor and transferring pre-processed SAR scanning data of all Tx-Rx antenna pairs to the mobile device; and processing the pre-processed SAR scanning data of all Tx-Rx antenna pairs, by a mobile device, to generate a 2-dimensional SAR image and determine presence or absence of a target in the area of interest behind the wall.

From above-mentioned embodiments, it may be seen that at least following beneficial effects may be achieved in the present disclosure.

The combination of gated (LFMCW), (TDMA) and MIMO switch antenna forming SAR radar may achieve the high-resolution detection with low power consumption. Proper weighting function (w) applied for distance may strengthen the detection in the range of interest and suppress other undesired sources/objects in different ranges (range zones). Laser measurement may further enhance the LMCW range gate setting and make measurement more accurate and quicker. Utilizing mobile device (Phone) calculation power to form radar image and display the results may reduce the radar design power consumption. Furthermore, using the phone camera and combining the camera with radar target display may be beneficial for the user (operator) to locate and view the target the target behind the wall and determine corresponding location and relative physical position.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. A through-wall detection system, comprising:
a synthetic aperture radar (SAR), configured to scan an area of interest behind a wall to obtain SAR scanning data, wherein the SAR includes a linear frequency-modulated continuous-wave (LFMCW) time-division multiple access (TDMA) multi-input multi-output (MIMO) SAR that includes:
an antenna system, including a plurality of transmitter (Tx)-antennas and a plurality of receiver (Rx)-antennas;
a main radar board, including a radar transmitter (Tx), a radar receiver (Rx), and a micro controller, wherein the micro controller includes a data processor; and
a radar switch board, including a logic control circuit, wherein the logic control circuit is configured to form a Tx-Rx antenna pair by selecting a Tx antenna from the plurality of Tx-antennas and selecting a Rx-antenna from the plurality of Rx-antennas each time in a predefined sequence;
a laser range finder, configured to estimate a distance between the SAR and the wall; and
a mobile device, wherein the data processor is configured to pre-process SAR scanning data of all Tx-Rx antenna pairs and transfer pre-processed SAR scanning data of all Tx-Rx antenna pairs to the mobile device; and the mobile device is configured to process the pre-processed SAR scanning data of all Tx-Rx antenna pairs to generate a 2-dimensional SAR image and determine presence or absence of a target in the area of interest behind the wall.

2. The detection system according to claim 1, wherein:
the mobile device includes a camera system that is configured to record an image of the area of interest scanned by the SAR and overlay the image of the area of interest with the 2-dimensional SAR image.

3. The detection system according to claim 2, wherein:
the camera system is further configured for infrared imaging and/or providing illumination.

4. The detection system according to claim 1, wherein:
the micro controller is further configured to use the distance, which is between the SAR and the wall and estimated by the laser range finder, to select a corner frequency of a high-pass filter to suppress a reflection signal adjacent to the target.

5. The detection system according to claim 1, wherein:
the micro controller is further configured to automatically select a range zone based on the distance which is between the SAR and the wall and estimated by the laser range finder, wherein the range zone is any one of a short-range zone, a medium-range zone and a long-range zone; and based on the range zone selected, apply a distance-dependent weight function to calculate a distance between the target and the SAR.

6. The detection system according to claim 5, wherein:
the distance-dependent weight function is defined as a distance between the SAR and the target=r^{4+w}, wherein r denotes the distance between the SAR and the wall, and w denotes a weighted value dependent on the range zone selected.

7. The detection system according to claim 6, wherein:
for the short-range zone, w is defined to be w>0;
for the medium-range zone, w is defined to be w=0; and
for the long-range zone, w is defined to be w<0.

8. The detection system according to claim 1, wherein:
the SAR operates at a range of 24.0-26.5 GHz.

9. The detection system according to claim 1, wherein:
the plurality of Tx-antennas and the plurality of Rx-antennas are arranged at an interval of ½ wavelength of a SAR operating frequency along a same axis.

10. The detection system according to claim 1, wherein:
the antenna system includes 6 Tx-antennas and 6 Rx-antennas; or 3 Tx-antennas and 4 Rx-antennas; or 1 Tx-antenna and 4 Rx-antennas.

11. The detection system according to claim 1, wherein:
the SAR is powered by one or more rechargeable batteries.

12. The detection system according to claim 1, wherein:
the mobile device is communicated with the SAR through a wired or wireless manner.

13. A through-wall detection method, comprising:
scanning an area of interest behind a wall with a synthetic aperture radar (SAR) to obtain SAR scanning data, wherein the SAR includes a linear frequency-modulated continuous-wave (LFMCW) time-division multiple access (TDMA) multi-input multi-output (MIMO) SAR that includes:
an antenna system, including a plurality of transmitter (Tx)-antennas and a plurality of receiver (Rx)-antennas;
a main radar board, including a radar transmitter (Tx), a radar receiver (Rx), and a micro controller, wherein the micro controller includes a data processor; and
a radar switch board, including a logic control circuit, wherein the logic control circuit is configured to form a Tx-Rx antenna pair by selecting a Tx antenna from the plurality of Tx-antennas and selecting a Rx-antenna from the plurality of Rx-antennas each time in a predefined sequence;
pre-processing SAR scanning data of all Tx-Rx antenna pairs by the data processor and transferring pre-processed SAR scanning data of all Tx-Rx antenna pairs to the mobile device; and
processing the pre-processed SAR scanning data of all Tx-Rx antenna pairs, by a mobile device, to generate a 2-dimensional SAR image and determine presence or absence of a target in the area of interest behind the wall.

14. The detection method according to claim 13, further including:
using the distance, which is between the SAR and the wall and estimated by a laser range finder, to select a corner frequency of a high-pass filter to suppress a reflection signal adjacent to the target.

15. The detection method according to claim 13, further including:
automatically selecting a range zone based on the distance which is between the SAR and the wall and estimated by the laser range finder, wherein the range zone is any one of a short-range zone, a medium-range zone and a long-range zone; and based on the range zone selected, applying a distance-dependent weight function to calculate a distance between the target and the SAR.

16. The detection method according to claim 15, wherein:
the distance-dependent weight function is defined as a distance between the SAR and the target=r^{4+w}, wherein r denotes the distance between the SAR and the wall, and w denotes a weighted value dependent on the range zone selected.

17. The detection method according to claim 16, wherein:
for the short-range zone, w is defined to be w>0;
for the medium-range zone, w is defined to be w=0; and
for the long-range zone, w is defined to be w<0.

18. The detection system according to claim 13, wherein:
the SAR operates at a range of 24.0-26.5 GHz.

19. The detection system according to claim 13, wherein:
the SAR is powered by one or more rechargeable batteries.

20. The detection system according to claim 13, wherein:
the mobile device is communicated with the SAR through a wired or wireless manner.
